(19) United States
(12) Patent Application Publication
(10) Pub. No.: US 2021/0286427 A1
(43) Pub. Date: Sep. 16, 2021

(54) ADDING A VIRTUAL OBJECT TO AN EXTENDED REALITY VIEW BASED ON GAZE TRACKING DATA

(71) Applicant: Tobii AB, Danderyd (SE)

(72) Inventor: Sourabh PATERIYA, Danderyd (SE)

(73) Assignee: Tobii AB, Danderyd (SE)

(21) Appl. No.: 16/915,089

(22) Filed: Jun. 29, 2020

(30) Foreign Application Priority Data
Jun. 27, 2019 (SE) 1950803-5

(51) Int. Cl. G06F 3/01; G06T 19/20; G06T 19/00

(52) U.S. Cl. CPC G06F 3/013; G06T 2219/2004; G06T 19/006; G06T 19/20

(57) ABSTRACT

A system, a head-mounted device, a computer program, a carrier and a method for adding a virtual object to an extended reality view based on gaze-tracking data for a user are disclosed. In the method the method, one or more volumes of interest in world space are defined. Furthermore, a position of the user in world space is obtained, and a gaze direction and a gaze convergence distance of the user are determined. A gaze point in world space of the user is then determined based on the determined gaze direction and gaze convergence distance of the user. On condition that the determined gaze point in world space is consistent with a volume of interest of the defined one or more one volumes of interest in world space, a virtual object is added to the extended reality view.

### CROSS REFERENCE TO RELATED APPLICATIONS

This application claims priority to Swedish Application No. 1950803-5, filed Jun. 27, 2019; the content of which are hereby incorporated by reference.

### TECHNICAL FIELD

The present disclosure relates to the field of eye tracking. In particular, the present disclosure relates to adding a virtual object in an extended reality view.

### BACKGROUND

For extended reality (XR), such as augmented reality (AR), augmented virtuality (AV), and virtual reality (VR), the extended reality view of the user will differ depending on how the head of the user is oriented and if the user moves. In extended reality devices, e.g. in the form of a head-mounted device, virtual objects, such as an information text or other information carrying virtual objects, can be added on a display of the device. The virtual objects may be fixed to screen space, i.e. such that they appear in the same place in relation to the user regardless of the position and orientation of the head of the user. The virtual objects may also be fixed to world space, i.e. such that they appear in the same position in the real world or a virtual world regardless of the position of the user and orientation of the user's head. In the latter case, a virtual object will be seen in the extended reality view of the user when a position in the real world or the virtual world where the virtual object is placed is in the field of view of the user.

One problem with prior art methods and systems, is that the virtual objects may be positioned such that they interfere with other relevant information or in other ways disturb or distract the view of the user to an unjustified extent. For example, a virtual object may interfere with real world or virtual world objects or other virtual objects, in particular if the number of virtual objects is large or if one or more of the virtual objects themselves are large.

Hence, enhanced devices and methods for positioning a virtual object in an extended reality view are desirable.

### SUMMARY

An object of the present disclosure is to mitigate, alleviate, or eliminate one or more of the above-identified deficiencies in the art and disadvantages singly or in any combination.

This object is obtained by a method, a system, a head-mounted device, a computer program and a carrier as defined in the independent claims.

According to a first aspect, a method for adding a virtual object to an extended reality view based on gaze-tracking data for a user is provided. In the method one or more volumes of interest in world space are defined. A position of the user in world space, and a gaze direction and a gaze convergence distance of the user are determined. A gaze point in world space of the user is then determined based on the determined gaze direction and gaze convergence distance of the user, and the determined position of the user. On condition that the determined gaze point in world space is consistent with a volume of interest of the defined one or more one volumes of interest in world space, a virtual object is added to the extended reality view.

By using the determined gaze point in world space of the user and conditioning adding of the virtual object on the determined gaze point being consistent with the volume of interest, the virtual object is not added just because the volume of interest is in the field of view of the user but the requirement is stricter. This will reduce the number of virtual objects added. The conditioning of the adding of the virtual object on the determined gaze point being consistent with the volume of interest, introduces a requirement on the user's gaze point. An intention of this is that the user shall with her or his gaze indicate interest in the volume of interest in order for the virtual object to be added. Furthermore, since condition is on the gaze point and not only on the gaze direction, the condition will also be on the gaze convergence distance. Hence, the virtual object will only be added if also the gaze convergence distance related to the determined gaze point is consistent with the volume of interest.

Extended reality generally refers to all combinations of completely real environments to a completely virtual environment. Examples are augmented reality, augmented virtuality, and virtual reality. However, for the present disclosure, examples include at least one virtual object to be added in the extended reality view of the user.

A virtual object refers, in the present disclosure, to an object introduced in a field of view of a user and which is not a real world object. The virtual object may for example be a text field, other geometric object or image of a real world object etc.

The position of the user in world space may be determined in absolute coordinates or it may be determined relative coordinates in relation to the one or more volume of interest in world space.

A gaze point is in the present disclosure a point in three dimensional space ate which the user is gazing.

In the present disclosure, world space refers to a space, usually three dimensional, such as the real world in case of an augmented reality application, or a virtual world in case of a virtual reality application, or a mixture of both. Adding the virtual object in the extended reality view in world space refers to adding the virtual object such that it is essentially locked in relation to world space in the field of view of the user. This means that the perspective changes based on where the user looks at the virtual object from either physically or virtually depending on application.

The one or more volumes of interest in world space defined, may for example relate to real world objects or virtual objects fixed to world space. A volume of interest could then for example be a volume comprising a real world object or a virtual object fixed to world space.

That a determined gaze point in world space is consistent with a volume of interest of the defined one or more one volumes of interest in world space, may for example be that the determined gaze point is within the volume of interest.

The virtual object may be added to the extended reality view fixed in screen space or fixed in world space.

The present disclosure is at least partly based on the realization that a virtual object can be added in an extended reality view of a user based on a gaze point in world space of a user. In more detail, the virtual object is added if the user is gazing at a gaze point in world space consistent with a volume of interest of defined one or more one volumes of interest in world space. A gaze point consistent with a volume of interest is interpreted as indication of interest in the volume of interest. The virtual object can be added in the extended reality view in world space based on an interpreted indication of interest which in turn makes it possible to refrain from adding other virtual objects in the extended reality view in which no indication of interest has been shown, e.g. by the user not gazing at gaze points consistent with volumes of interest related to such other virtual objects. This enables adding virtual objects not interfering with other relevant information or in other ways disturbing or distracting the view of the user to an unjustified extent.

In embodiments, a gaze duration during which the user is gazing at the determined gaze point in world space is determined. The virtual object is added in the extended reality view on condition that the determined gaze duration is longer than a predetermined gaze duration threshold.

Maintaining a gaze point consistent with a volume of interest for a predetermined gaze duration or longer is interpreted as indication of interest in the volume of interest. The virtual object can be added in the extended reality view in world space based on an interpreted indication of interest which in turn makes it possible to refrain from adding other virtual objects in the extended reality view in which no indication of interest has been shown, e.g. by the user not gazing longer than the predetermined gaze duration at gaze points consistent with volumes of interest related to such other virtual objects. This enables adding virtual objects not interfering with other relevant information or in other ways disturbing or distracting the view of the user to an unjustified extent.

In further embodiments, the virtual object displayed in the extended reality view is removed from the extended reality view after a predetermined amount of time.

By removing the virtual object from the extended reality view after a predetermined amount of time, the virtual object will interfere with other relevant information or in other ways disturb or distract the view of the user only for the predetermined amount of time.

In embodiments, it is determined that the user stops gazing at the determined gaze point in world space, at said volume of interest, or at the virtual object. The virtual object displayed in the extended reality view is then removed from the extended reality view after a predetermined amount of time after determining that the user stops gazing at the determined gaze point in world space , at said volume of interest, or at the virtual object, respectively.

If the user stops gazing at the determined gaze point consistent with the volume of interest, this is interpreted as indication of the user not being interest any more of the volume of interest. The virtual object is then removed from the extended reality view after a predetermined amount of time. Hence, the virtual object will interfere with other relevant information or in other ways disturb or distract the view of the user only as long as (and for a predetermined amount of time further) the user is gazing at a gaze point consistent with the volume of interest. The removing of the virtual object may also be governed by the user stopping gazing at the volume of interest or at the virtual object. For example, the virtual object may not be positioned at the determined gaze point consistent with the volume of interest but may for example be positioned such that it does not overlap the determined gaze point or even the volume of interest. The user would then stop gazing at the determined gaze point and start gazing at the virtual object. In such a case, the virtual object should be maintained in the extended reality view at least as long as the user is gazing at the virtual object, and optionally also a predetermined amount of time after the user stops gazing at the virtual object or after determining that the user stops gazing at the virtual object.

In other embodiments, the virtual object is visually removed by gradually disappearing during a predetermined period of time from the extended reality view.

By visually removing the virtual object by making it gradually disappear, the visual removing will be less abrupt which reduces distraction of the removing. For example, if the virtual object is added and is then removed because the user is not gazing at a gaze point consistent with the volume of interest, the virtual object may be in a periphery of the user's field of view. As such, smooth removing, by gradually disappearing will be less salient. Also, if the user again wants to see the virtual object, during the predetermined amount of time it will be possible to identify the virtual object again before it has been completely removed.

For example, the virtual object may be made to gradually disappear by making it more and more transparent.

In embodiments, the virtual object added to the extended reality view comprises information related to said volume of interest of the defined one or more one volumes of interest in world space. For example, the volume of interest may comprise a real world object or a virtual world object, such as a building, a business or other object, and the virtual object may include information related to that building, business or other object. For example, the virtual object may be an information box, including name of, opening hours, facilities etc. relating to the building, business or other object.

In further embodiments, the virtual object is added to the extended reality view in a position fixed in world space in relation to the volume of interest of the defined one or more one volumes of interest. For example, the virtual object may be fixed in world space within or close to the volume of interest, or such that an association to the volume of interest is indicated. For example, a line or arrow from the virtual object to the volume of interest could be included in the extended reality view.

Optionally, icons, such as a filled circles, can be provided in the extended reality view of the user. The icons may be positioned within or close to the volume of interest and indicate that a virtual object will be added if the user gazes at the icon or within the volume of interest.

Adding an icon will make it easier for a user to identify where virtual objects, such as information boxes, can be added. Hence, the user can choose whether to maintain a gaze point on the icon for the predetermined amount of time or not in order for the virtual object to be added or not. This enables adding virtual objects not interfering with other relevant information or in other ways disturbing or distracting the view of the user to an unjustified extent.

According to a second aspect, a system comprising a display, a processor and a memory is provided. The memory contains instructions executable by the processor, whereby the system is operative to define one or more volumes of interest in world space. Furthermore, a position of the user in world space is obtained. A gaze direction and a gaze convergence distance of the user are determined, and a gaze point in world space of the user is determined based on the determined gaze direction and gaze convergence distance of the user, and the determined position of the user. On condition that the determined gaze point in world space is consistent with a volume of interest of the defined one or more one volumes of interest in world space, add a virtual object to the extended reality view.

Embodiments of the system according to the second aspect may for example include features corresponding to the features of any of the embodiments of the method according to the first aspect.

According to a third aspect, a head-mounted device is provided comprising the system of the second aspect.

Embodiments of the head-mounted device according to the third aspect may for example include features corresponding to the features of any of the embodiments of the system according to the second aspect.

According to a fourth aspect, a computer program is provided. The computer program, comprises instructions which, when executed by at least one processor, cause at least one processor to define one or more volumes of interest in world space. Furthermore, a position of the user in world space is obtained. A gaze direction and a gaze convergence distance of the user are determined, and a gaze point in world space of the user is determined based on the determined gaze direction and gaze convergence distance of the user, and the determined position of the user. On condition that the determined gaze point in world space is consistent with a volume of interest of the defined one or more one volumes of interest in world space, add a virtual object to the extended reality view.

Embodiments of the computer program according to the fourth aspect may for example include features corresponding to the features of any of the embodiments of the method according to the first aspect.

According to a fifth aspect, a carrier comprising a computer program according to the third aspect is provided. The carrier is one of an electronic signal, optical signal, radio signal, and a computer readable storage medium.

Embodiments of the carrier according to the fifth aspect may for example include features corresponding to the features of any of the embodiments of the method according to the first aspect.

### BRIEF DESCRIPTION OF THE DRAWINGS

The foregoing will be apparent from the following more particular description of the example embodiments, as illustrated in the accompanying drawings in which like reference characters refer to the same parts throughout the different views. The drawings are not necessarily to scale, emphasis instead being placed upon illustrating the example embodiments.

FIG. 1 is a flowchart illustrating embodiments of a method according to the present disclosure.

FIGS. 2a and 2b are schematic views of extended reality views of a user in relation to embodiments of a method, system and head-mounted device according to the present disclosure.

FIG. 3 is a block diagram illustrating embodiments of a system according to the present disclosure.

FIGS. 4a and 4b shows a head-mounted device and a remote display system, respectively, according to one or more embodiments of the present disclosure.

All the figures are schematic, not necessarily to scale, and generally only show parts which are necessary in order to elucidate the respective example, whereas other parts may be omitted or merely suggested.

### DETAILED DESCRIPTION

Aspects of the present disclosure will be described more fully hereinafter with reference to the accompanying drawings. The apparatus and method disclosed herein can, however, be realized in many different forms and should not be construed as being limited to the aspects set forth herein. Like numbers in the drawings refer to like elements throughout.

The terminology used herein is for the purpose of describing particular aspects of the disclosure only, and is not intended to limit the invention. As used herein, the singular forms “a”, “an” and “the” are intended to include the plural forms as well, unless the context clearly indicates otherwise.

In the following, descriptions of examples of methods and devices for adding of a virtual object in an extended reality view of a user are provided. Generally, a virtual object in an extended reality application can be added in relation to world space, i.e. in relation to coordinates in a world space to which the extended reality application relates. As such, if the virtual object positioned in a field of view of the user of an extended reality device is to appear to be static in world space, it will not be positioned in a static position on one or more display of the extended reality device. Instead, the position of the virtual object on the one or more displays will be adapted when the user changes position and/or turns her or his head in order to make the virtual object appear as if it is positioned fixed in world space. Alternatively, the virtual object may be positioned on one or more displays fixed to screen space. In such a case, the virtual object will be positioned in a static position on the one or more displays of the extended reality device and will not be affected regardless if the user changes position and/or turns her or his head.

When adding a virtual object to the extended reality view, it may interfere with other relevant information or in other ways disturb or distract the view of the user to an unjustified extent. For example, the virtual object may interfere with real world objects or other virtual objects, in particular if the number of virtual objects is large or if one or more of the virtual objects themselves are large.

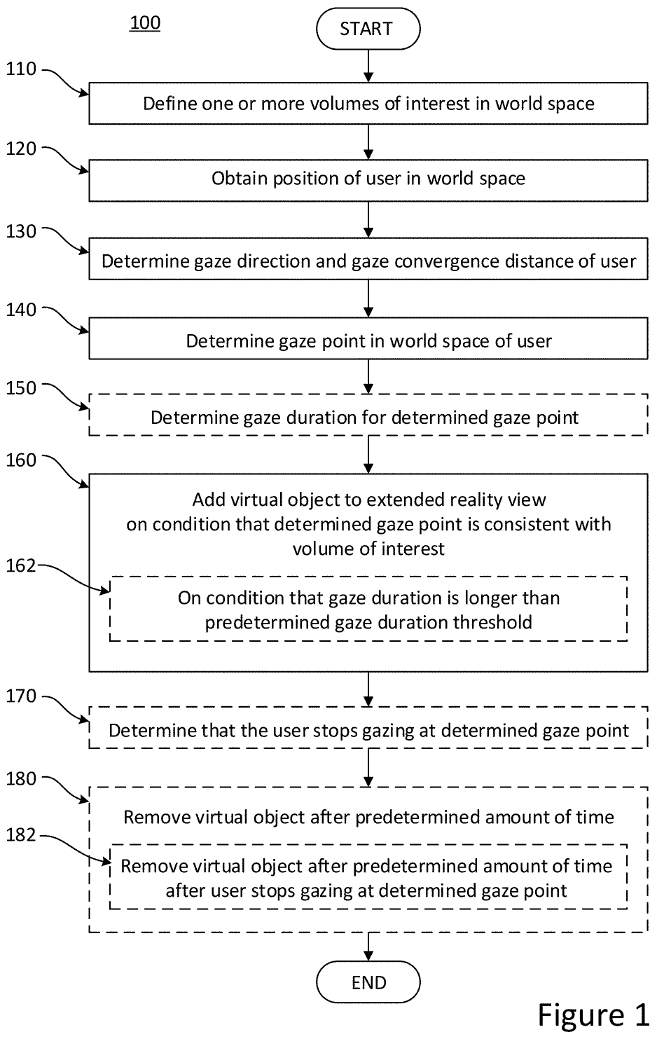

FIG. 1 is a flowchart illustrating embodiments of a method 100 for adding a virtual object to an extended reality view based on gaze-tracking data for a user. Depending on the application, the virtual object to be added may be one of a number of different types. In an augmented reality application, it may a virtual object, such as a text box, that provides information regarding real world objects or virtual world objects related to the volume of interest. It is to be noted, that the type of virtual object is not essential to the present disclosure. Rather, the present disclosure aims to, at least to some extent, add the virtual object without the virtual object interfering with other relevant information or in other ways disturbing or distracting the view of the user to an unjustified extent. This is achieved by conditioning adding of the virtual object on the gaze point of the user. By determining the gaze point from both the gaze direction and the gaze convergence distance of the user, more specific conditions can be made such that the virtual object is only added if the gaze point indicates that the user is interested in an object, e.g. by adding the virtual object only if the gaze point is within a volume of interest comprising the object.

In the method 100 one or more volumes of interest in world space are defined 110. The one or more volumes of interest in world space may for example relate to real world objects or virtual objects fixed to world space. A volume of interest could then for example be a volume comprising a real world object or a virtual object fixed to world space. In an augmented reality, the volume of interest may comprise a real or virtual world object, such as a building, a business or other object, and the virtual object may include information related to that building, business or other object. For example, the virtual object may be an information box, including name of, opening hours, facilities etc. relating to the building, business or other object.

Furthermore, a position of the user in world space is obtained 120. The position of the user in world space may be determined in absolute coordinates or it may be determined relative coordinates in relation to the one or more volume of interest in world space. The position can be determined by means internal to a device the method is performed in or can be received from another device. The means of determining the position is not essential as long as a precision required is achieved.

A gaze direction and a gaze convergence distance of the user are determined 130. Determining gaze direction or gaze vectors of the user's eyes is generally performed by means of gaze-tracking means. The convergence distance may then be determined as the distance where the gaze directions or gaze vectors of the user's eyes converge. The exact way the gaze direction and gaze convergence distance of the user are determined is not essential to the present disclosure. Any suitable methods may be used achieving a required precision.

A gaze point in world space of the user is then determined 140 based on the determined gaze direction and gaze convergence distance of the user, and the determined position of the user.

On condition that the determined gaze point in world space is consistent with a volume of interest of the defined one or more one volumes of interest in world space, a virtual object is added 160 to the extended reality view. That the determined gaze point in world space is consistent with the volume of interest of the defined one or more one volumes of interest in world space, may be that the determined gaze point is within the volume of interest.

Optionally, icons, such as a filled circles or spheres, can be provided in the extended reality view of the user. The icons may be positioned within or close to the volume of interest. The icon would in such a case signal to the user that a virtual object will be added if the user gazes at the icon or within the volume of interest. In such a case, that determined gaze point (i.e. both the gaze direction and gaze convergence distance) in world space is consistent with the volume of interest of the defined one or more one volumes of interest in world space, may be that the determined gaze point is on the icon.

When the virtual object is added to the extended reality view, it may be fixed in screen space or fixed in world space.

Since the condition is on the gaze point and not only on the gaze direction, the condition will also be on the gaze convergence distance. Hence, the virtual object will only be added if also the gaze convergence distance related to the determined gaze point is consistent with the volume of interest. For methods where only the gaze direction is used as a condition, virtual objects will be added even if the user is actually gazing at a gaze point with a different gaze convergence distance. Hence, virtual objects will be added which does not reflect an interest shown by the user in terms of a gaze point of the user.

In the method 100, a gaze duration during which the user is gazing at the determined gaze point in world space can be determined 150. The virtual object is then added in the extended reality view on the further condition 162 that the determined gaze duration is longer than a predetermined gaze duration threshold.

Maintaining a gaze point consistent with a volume of interest for a predetermined gaze duration or longer is interpreted as indication of interest in the volume of interest. The predetermined gaze duration threshold is preferably adapted such that the virtual object is added only when the user has clear intention to cause the virtual object to be added.

After the virtual object has been added, it may later be removed 180 from the extended reality view after a predetermined amount of time. The predetermined amount of time may depend on the virtual object, such as the amount of information included in the virtual object.

In the method 100, it may further be determined 170 that the user stops gazing at the determined gaze point in world space. In addition to or in alternative to removing the virtual object after the predetermined amount of time (from when it was added), the virtual object may instead be removed from the extended reality view after a predetermined amount of time after determining that the user stops gazing at the determined gaze point in world space.

If the user stops gazing at the determined gaze point consistent with the volume of interest, this is interpreted as indication of the user not being interest any more of the volume of interest. The virtual object is then removed 182 from the extended reality view after a predetermined amount of time after the user stops gazing at the determined gaze point.

If the virtual object is added in a position outside the volume of interest, the removal of the virtual object can instead be governed by a determined point in time when the user stops gazing at the virtual object, such that the virtual object is removed from the extended reality view after a predetermined amount of time after determining that the user stops gazing at the virtual object.

The virtual object may be visually removed directly after the predetermined amount of time or it may be removed by gradually disappearing during a predetermined period of time from the extended reality view. For example, the virtual object may be made more and more transparent over the predetermined amount of time.

The virtual object may be added to the extended reality view in a position fixed in world space in relation to the volume of interest of the defined one or more one volumes of interest. For example, the virtual object may be fixed in world space within or close to the volume of interest, or such that an association to the volume of interest is indicated or implicit. For example, a line or arrow from the virtual object to the volume of interest could be included in the extended reality view.

Even if the virtual object is fixed in world space, the virtual object may be rotated in world space such that it always faces the user. For a virtual object in the form of a text box, the text box may be fixed in world space to the extent that it is always at the same distance from the volume of interest but the text box will be adapted such that it is facing the user regardless how the user moves in relation to the volume of interest.

In alternative, the virtual object may be added to the extended reality view in a position fixed in screen space. For example, the virtual object may be added fixed in screen space such that the user can view it in the same place in screen space regardless on the orientation of the user's head or how the user moves.

In case icons, such as a filled circles or spheres, are provided in the extended reality view of the user positioned within or close to the volume of interest and indicating to the user that a virtual object will be added if the user gazes at the icon or within the volume of interest, the virtual object may be added over or close to the an icon relating to the volume of interest.

FIG. 1 comprises some steps that are illustrated in boxes with a solid border and some steps that are illustrated in boxes with a dashed border. The steps that are comprised in boxes with a solid border are operations that are comprised in the broadest example embodiment. The steps that are comprised in boxes with a dashed border are example embodiments that may be comprised in, or a part of, or are further operations that may be taken in addition to the operations of the border example embodiments. The steps do not all need to be performed in order and not all of the operations need to be performed. Furthermore, at least some of the steps may be performed in parallel.

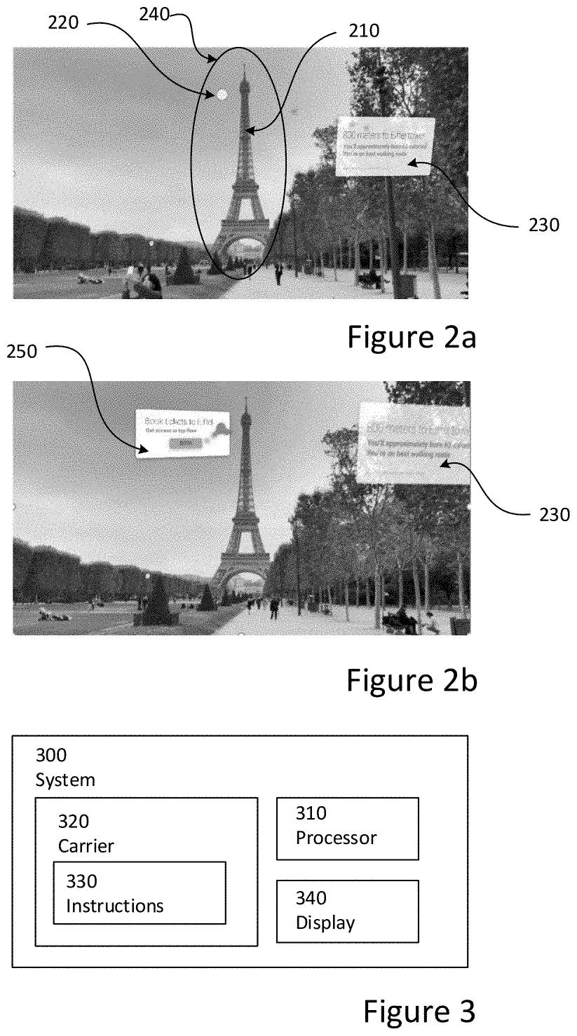

FIGS. 2a and 2b illustrate extended reality views of a user in relation to embodiments of a method, system and head-mounted device according to the present disclosure. The extended reality view of the user illustrated in FIG. 2a includes the Eiffel tower 210, an icon 220, a virtual object in the form of a first text box 230, and a volume of interest 240. The text box 230 has been added to the extended reality view of the user after the user has gazed at another icon (not shown) associated with another volume of interest (not shown) for a gaze duration longer than the predetermined gaze duration threshold. The user then stops gazing at the other icon and starts gazing at the icon 220. When the user has gazed at the icon 220 for a gaze duration longer than a predetermined gaze duration threshold, a virtual object in the form of a second text box 250 is added in the extended reality view. This is shown in the extended reality view of the user illustrated in FIG. 2b. At the same, the first text box 230 is made to gradually disappear by making it more and more transparent.

Including the icon 220 at the side of the Eiffel tower 210 in the extended reality view, enables the user to look at the Eiffel tower 210 without the virtual object being added and obscuring the view. On the other hand, the icon 220 is clearly associated with the Eiffel tower 210 and easily identified so the user can choose to gaze at the icon 220 in order for the virtual object in the form of the second text box 250 to be added.

Methods for adding a virtual object in an extended reality view of a user and steps therein as disclosed herein, e.g. in relation to FIG. 1, may be implemented in a system 300 of FIG. 3. The system 300 includes extended reality and gaze tracking functionality, and comprises a processor 310, and a carrier 320 including computer executable instructions 330, e.g. in the form of a computer program, that, when executed by the processor 310, cause the system 300 to perform the method. The carrier 320 may for example be an electronic signal, optical signal, radio signal, a transitory computer readable storage medium, and a non-transitory computer readable storage medium. Generally, the system will comprise at least one display 340. Virtual objects in an extended reality view of the system can be positioned in relation to world space, i.e. in relation to coordinates in a world space to which the system 300 relates. As such, if the virtual object positioned in a field of view of a user of the system is to appear to be static in world space, it will not be positioned in a static position on the at least one display 340 of the system 300. Instead, the virtual object will be moved around on the at least one display 340 when the user changes position and/or turns her head in order to make the virtual object appear as if it is positioned fixed in world space.

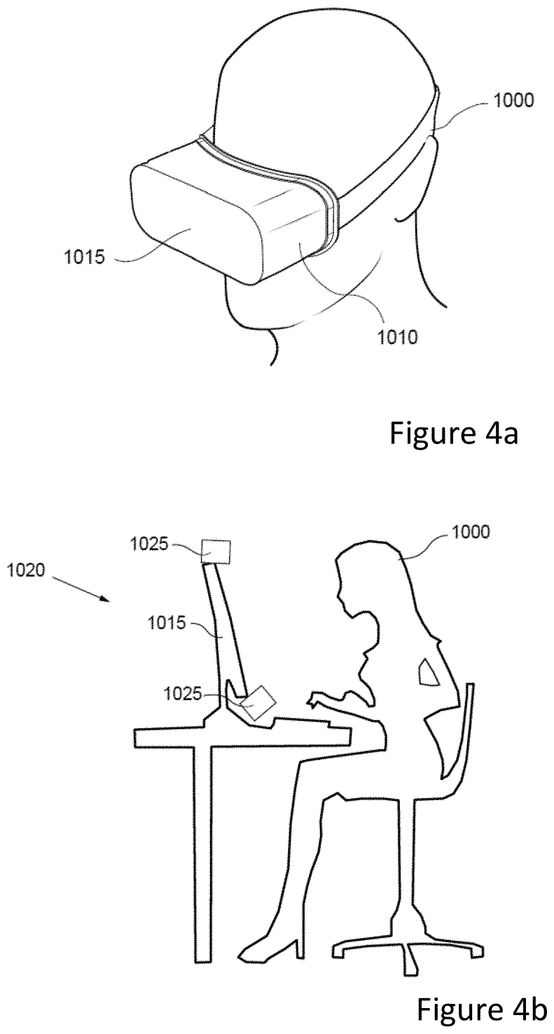

The system 300 may for example be implemented in a head-mounted device as illustrated in FIG. 4a or in a remote display system as illustrated in FIG. 4b.

FIG. 4a shows a head-mounted device 1010 according to one or more embodiments. The head-mounted device 1010, is a device which may optionally be adapted to be mounted (or arranged) at the head of a user 1000, as shown in FIG. 4a. The head-mounted device 1010 may e.g. comprise and/or be comprised in a head-mounted display, HMD, such as a VR headset, an AR headset or an MR headset. The head-mounted device 1010 or HMD comprises a displaying device 1015, which is able to visualize a plurality of objects in response to a control signal received from a computer. The displaying device 1015 may be transparent for real world experiences and non-transparent for virtual world experience. The head-mounted device 1010 is typically further configured to provide eye tracker functionality by a gaze tracking signal using one or more gaze tracking sensors (not shown), e.g. indicative of a gaze direction and/or a convergence distance. In other words, the head-mounted device 1010 is configured to provide an indication of an object the user is looking at and/or a depth at which the user is looking/watching. Preferably, the head-mounted device 1010 comprises one eye tracker for each eye.

The displaying device 1015 may for example be 3D display, such as a stereoscopic display. The 3D display may for example be comprised glasses equipped with AR functionality. Further, the 3D display may be a volumetric 3D display, being either autostereoscopic or automultiscopic, which may indicate that they create 3D imagery visible to an unaided eye, without requiring stereo goggles or stereo head-mounted displays. Consequently, as described in relation to FIG. 4a, the 3D display may be part of the head-mounted device 1010.

In an alternative embodiment, the displaying device 1015 is a physical display such as a screen of a computer, tablet, smartphone or similar, and the selectable object is displayed at the physical display.

FIG. 4b shows a remote display system 1020 according to one or more embodiments comprising a display device 1015. The remote display system 1020 typically comprises a remote display device 1015 in the form of a 3D display, as described in relation to FIG. 4a. The 3D display is remote in the sense that it is not located in the immediate vicinity of the user 1000. The remote display system 1020 is typically further configured to provide eye tracker functionality by a gaze tracking signal using one or more gaze tracking sensors 1025, e.g. indicative of a gaze direction and/or a convergence distance. In other words, the remote display system 1020 is configured to provide an indication of an object the user 1000 is looking at and/or a depth at which the user is looking/watching. As can be seen from FIG. 4b, the remote 3D display does not require stereo/stereoscopic goggles or stereo/stereoscopic head-mounted displays. In a further example, the 3D display is a remote display, where stereoscopic glasses are needed to visualize the 3D effect to the user. The remote display system 1020 may comprise only one eye tracker for both eyes. In other words, the illuminator(s) and the image device(s) are arranged to illuminate/read both eyes of the user.

A person skilled in the art realizes that the present invention is by no means limited to the embodiments described above. On the contrary, many modifications and variations are possible within the scope of the appended claims.

Additionally, variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The terminology used herein is for the purpose of describing particular aspects of the disclosure only, and is not intended to limit the invention. The division of tasks between functional units referred to in the present disclosure does not necessarily correspond to the division into physical units; to the contrary, one physical component may have multiple functionalities, and one task may be carried out in a distributed fashion, by several physical components in cooperation. A computer program may be stored/distributed on a suitable non-transitory medium, such as an optical storage medium or a solid-state medium supplied together with or as part of other hardware, but may also be distributed in other forms, such as via the Internet or other wired or wireless telecommunication systems. The mere fact that certain measures/features are recited in mutually different dependent claims does not indicate that a combination of these measures/features cannot be used to advantage. Method steps need not necessarily be performed in the order in which they appear in the claims or in the embodiments described herein, unless it is explicitly described that a certain order is required. Any reference signs in the claims should not be construed as limiting the scope.

1. A method for adding a virtual object to an extended reality view based on gaze-tracking data for a user, the method comprising:
defining one or more volumes of interest in world space;
obtaining a position of the user in world space;
determining a gaze direction and a gaze convergence distance of the user;
determining a gaze point in world space of the user based on the determined gaze direction and gaze convergence distance of the user, and the determined position of the user; and
on condition that the determined gaze point in world space is consistent with a volume of interest of the defined one or more one volumes of interest in world space, adding a virtual object to the extended reality view.

2. The method according to claim 1, further comprising:
determining a gaze duration during which the user is gazing at the determined gaze point in world space,
wherein the virtual object is added in the extended reality view on condition that the determined gaze duration is longer than a predetermined gaze duration threshold.

3. The method according to claim 1, wherein the virtual object displayed in the extended reality view is removed from the extended reality view after a predetermined amount of time.

4. The method according to claim 1, further comprising:
determining that the user stops gazing at the determined gaze point in world space, at said volume of interest, or at the virtual object,
wherein the virtual object displayed in the extended reality view is removed from the extended reality view after a predetermined amount of time after determining that the user stops gazing at the determined gaze point in world space, at said volume of interest, or at the virtual object.

5. The method according to claim 3, wherein the virtual object is visually removed by gradually disappearing during a predetermined amount of time from the extended reality view.

6. The method according to claim 1, wherein the virtual object added to the extended reality view comprises information related to said volume of interest of the defined one or more one volumes of interest in world space.

7. The method according to claim 1, wherein the virtual object is added to the extended reality view in a position fixed in world space in relation to the volume of interest of the defined one or more one volumes of interest.

8. A system comprising a processor, a display, and a memory, said memory containing instructions executable by said processor, whereby said system is operative to:
define one or more volumes of interest in world space;
obtain a position of the user in world space;
determine a gaze direction and a gaze convergence distance of the user;
determine a gaze point in world space of the user based on the determined gaze direction and gaze convergence distance of the user, and the determined position of the user; and
on condition that the determined gaze point in world space is consistent with a volume of interest of the defined one or more one volumes of interest in world space, add a virtual object to the extended reality view.

9. The system according to claim 8, further operative to:
determine a gaze duration during which the user is gazing at the determined gaze point in world space,
wherein the virtual object is added in the extended reality view on condition that the determined gaze duration is longer than a predetermined gaze duration threshold.

10. The system according to claim 8, wherein the virtual object displayed in the extended reality view is removed from the extended reality view after a predetermined amount of time.

11. The system according to claim 8, further operative to:
determine that the user stops gazing at the determined gaze point in world space, at the volume of interest, or at the virtual object,
wherein the virtual object displayed in the extended reality view is removed from the extended reality view after a predetermined amount of time after determining that the user stops gazing at the determined gaze point in world space , at the volume of interest, or at the virtual object.

12. The system according to claim 10, further operative to visually remove the virtual object by making the virtual object gradually disappearing during a predetermined amount of time from the extended reality view.

13. The system according to claim 8, wherein the virtual object added to the extended reality view comprises information related to said volume of interest of the defined one or more one volumes of interest in world space.

14. The system according to claim 8, further operative to add the virtual object to the extended reality view in a position fixed in world space in relation to the volume of interest of the defined one or more one volumes of interest.

15. A head-mounted device comprising the system of claim 8.

16. A computer program, comprising instructions which, when executed by at least one processor, cause at least one processor to:
define one or more volumes of interest in world space;
obtain a position of the user in world;
determine a gaze direction and a gaze convergence distance of the user;
determine a gaze point in world space of the user based on the determined gaze direction and gaze convergence distance of the user, and the determined position of the user; and
on condition that the determined gaze point in world space is consistent with a volume of interest of the defined one or more one volumes of interest in world space, add a virtual object to the extended reality view.

17. A carrier comprising a computer program according to claim 16, wherein the carrier is one of an electronic signal, optical signal, radio signal, and a computer readable storage medium.
